(19) United States
(12) Patent Application Publication
(10) Pub. No.: US 2002/0075149 A1
(43) Pub. Date: Jun. 20, 2002

(54) Method of monitoring a network kiosk

(75) Inventors: John C. Goodwin III, Suwanee, GA (US); John Brian Francis, Alpharetta, GA (US)

Correspondence Address: Paul W. Martin, NCR Corporation, Law Department, ECD-2, 101 West Schantz Avenue, Dayton, OH, 45479-0001, US

(73) Assignee: NCR Corporation

(21) Appl. No.: 09/727,331

(22) Filed: Nov. 29, 2000

(51) Int. Cl. G06F 15/00

(52) U.S. Cl. 340/540

(57) ABSTRACT

A method of monitoring a network kiosk which sends errors to a reporting computer to facilitate quicker repairs. The method includes the steps of determining kiosk components to monitor by the kiosk, determining operating errors for a number of the kiosk components by the kiosk, storing the operating errors in a log, sending the log to a reporting computer by the kiosk, and generating an error report for service personnel from the log by the reporting computer.

### BACKGROUND OF THE INVENTION

The present invention relates to self-service kiosks and more specifically to a method of monitoring a network kiosk.

Retailers have a desire to sell their products over networks, such as global networks which are a part of the World Wide Web (WWW or “web”) and which use the Transmission Control Protocol/Internet Protocol (TCP/IP protocol). These retailers wish to provide Internet server web sites which offer the same features as Internet server web sites available to home shoppers who use their computers to connect to the Internet server web sites.

Kiosks provide a publicly-accessible computing platform for displaying web pages from retailer web sites. Kiosks may be located within a retailer's transaction establishment or elsewhere, such as in shopping malls. Kiosks may be easily networked to retailer web sites using the TCP/IP protocol. Web pages from web sites may be displayed using known and available web software, such as Microsoft® Internet Explorer software.

Monitoring kiosks for operational readiness can be expensive and require much overhead. Therefore, it would be desirable to provide a method of monitoring a network kiosk which is low in cost and which can operate on a standard network infrastructure.

### SUMMARY OF THE INVENTION

In accordance with the teachings of the present invention, a method of monitoring a network kiosk is provided.

The method includes the steps of determining kiosk components to monitor by the kiosk, determining operating errors for a number of the kiosk components by the kiosk, storing the operating errors in a log, sending the log to a reporting computer by the kiosk, and generating an error report for service personnel from the log by the reporting computer.

It is accordingly an object of the present invention to provide a method of monitoring a network kiosk.

It is another object of the present invention to monitor kiosk components for operating errors and log the errors.

It is another object of the present invention to schedule monitoring of kiosk components for operating errors.

It is another object of the present invention to send kiosk operating errors to a reporting computer to facilitate faster repairs by service personnel.

It is another object of the present invention to send kiosk operating errors via email, such as when a firewall exists at the site of the reporting computer and blocks direct transfer of operating errors to the reporting computer.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a transaction processing system including a network kiosk;

FIG. 2 is a depiction of a monitored component file;

FIG. 3 is a depiction of a kiosk information file;

FIG. 4 is a depiction of a host information file; and

FIG. 5 is a flow diagram illustrating the monitoring method of the present invention.

### DETAILED DESCRIPTION OF THE PREFERRED EMBODIMENT

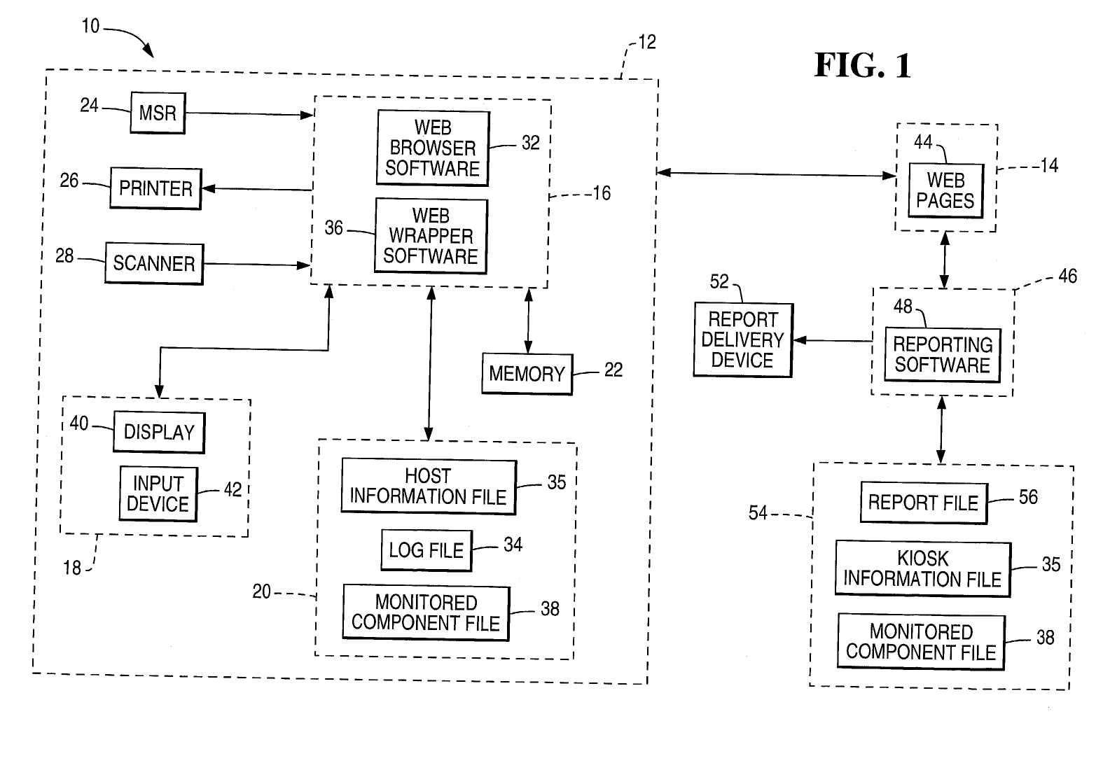

Turning now to FIG. 1, transaction system 10 includes kiosk 12, network 14, and reporting computer 46. Kiosk 12 is preferably located within a transaction establishment, such as a retail store, or transaction environment, such as a shopping mall. Kiosk 12 may include an NCR 7401 computer.

Kiosk 12 primarily includes processor 16, touch screen 18, memory 20, and storage medium 22. Kiosk 12 may additionally include a number of peripherals, including magnetic strip reader (MSR) 24, printer 26, and scanner 28.

To assist with execution of certain tasks performed by kiosk 12, kiosk 12 includes a built-in time keeping device, commonly referred to as a system clock, which is synchronized with current time, in order to automatically execute the tasks at their scheduled times.

Processor 16 controls operation of kiosk 12 and executes web browser software 32 and web wrapper software 36.

Web browser software 32 allows an operator to access information and purchase products from retailers through network 14, which preferably includes World Wide Web (WWW or “web”) servers. Web browser software 32 may include commercially-available web browser software, such as Microsoft® Internet Explorer web browser software. Microsoft® Internet Explorer web browser software is configured into a kiosk operation using a “-k” command line option. This option hides toolbars and menubars to prevent operator access to those functions.

Web browser software 32 retrieves and displays web pages 44 from network 14, which includes a plurality of interconnected servers. Web pages 44 include web pages which display information about products and services offered by the kiosk owner as well as other web pages. Web pages 44 assist operators to find information about products sold by the kiosk owner and to complete purchases of such products. For this purpose, web pages 34 may include a start or “home” page which operates as a default page from which operation begins and to which operation returns when an operator is finished using kiosk 12. Web pages 44 may be written using hypertext markup language (HTML) or other suitable web page language.

Web wrapper software 36 provides security functions. During operation, web wrapper software 36 prevents an operator from accessing kiosk files, other applications, the operating system software, or basic input-output system (BIOS) firmware, and prevents the operator from causing kiosk 12 to reboot.

Under the present invention, web wrapper software 36 additionally monitors named components, such as peripherals MSR 24, printer 26, and bar code reader 28, for operational problems. Web wrapper software 36 stores component status information in log file 34 and reports the component status information to reporting computer 46, either on a scheduled basis or when requested by reporting computer 46. Components to be monitored may be coded into web wrapper software 36 or listed in monitored component file 38 to allow a kiosk owner to control operation.

Reporting computer 46 may be located at a company which services kiosk 12. Reporting computer 46 executes monitoring and reporting software 48. Monitoring and reporting software 48 may monitor a number of kiosks 12. Kiosk information, including kiosk addresses, may be listed in kiosk information file 50 to allow a service provider to control monitoring. Kiosk addresses may include Internet Protocol (IP) addresses.

Network communication between kiosk 12 and reporting computer 46 may be through any known communication method. Reporting computer information, including a host address, may be listed in host information file 35. In addition, web wrapper software 36 may send log file 34 to reporting computer 46 via electronic mail in order to pass through a corporate firewall, if the service provider is running one to protect its internal network. Reporting computer 46 may also disseminate monitored component files 38 to kiosks 12.

Monitoring and reporting software 48 generates report file 56 from the operational status information in log file 34 from kiosk 12. Report file 56 may be formatted in any standard document type, such as ASCII text format or hypertext markup language (HTML). Report delivery device 52 delivers report file 56 to service personnel and may include a display device or printer.

Reporting computer 46 stores monitored component files 38 and kiosk information file 50 in storage medium 54.

Touch screen 18 includes display 40 and input device 42. Display 40 and input device 42 may also be separate units. Input device 42 may record personal information from an operator.

Memory 20 is used by processor 16 to store executed program information, including web wrapper software information.

Storage medium 22 stores software including web wrapper software 36.

MSR 24 reads loyalty, credit, debit, SMART, and/or other types of cards carried by an operator. MSR 24 may record personal information from an operator.

Printer 26 prints information from web wrapper software 32, including information on web pages 44 from network 14. For example, printer 26 may print information relevant to a transaction completed by an operator using kiosk 12.

Scanner 28 reads bar codes on products to obtain product identification numbers. Kiosk 12 queries a transaction server with the identification numbers to obtain information about the product and displays the information.

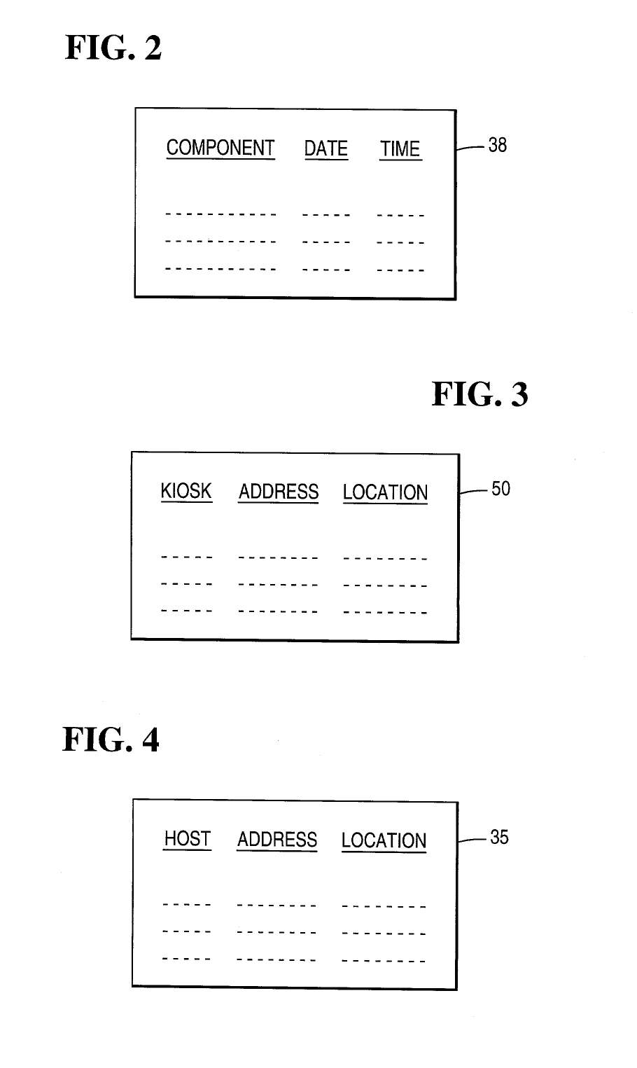

Turning now to FIG. 2, monitored component file 38 includes entries COMPONENT, DATE, and TIME.

Entry COMPONENT identifies a particular component within kiosk 12.

Entry DATE identifies a particular date for monitoring a component within kiosk 12.

Entry TIME identifies a particular time period for monitoring a component within kiosk 12.

Monitored components may include touch screen 18, storage medium 20, memory 22, MSR 24, printer 26, scanner 28, and subcomponents of some of these elements.

For example, a component may include all monitorable components of scanner 28 or specified subcomponents of scanner 28. Monitored scanner subcomponents may include a motor, laser, photodetector, or bar code decoding circuit within scanner 28.

Turning now to FIG. 3, kiosk information file 50 includes entries KIOSK, ADDRESS, and LOCATION.

Entry KIOSK identifies a particular kiosk 12.

Entry ADDRESS identifies a network address of the kiosk, such as an IP address.

Entry LOCATION identifies a particular location of kiosk 12.

Web wrapper software 36 reads monitored component file 38 and initiates monitoring of listed components at the scheduled dates and times or upon receipt of a command to begin monitoring one or more components from reporting computer 46. Web wrapper software 36 stores status data in log file 34. Web wrapper software 36 sends log file 34 to reporting computer 46 either on a scheduled basis or when requested by reporting computer 46. Reporting computer 46 generates report file 56, which it sends to report delivery device 52, for display or printing. Service personnel may then use report file 56 to troubleshoot operating errors in monitored components.

Turning now to FIG. 4, host information file 35 includes entries HOST, ADDRESS, and LOCATION.

Entry HOST identifies a particular monitoring and reporting computer 46.

Entry ADDRESS identifies a network address of reporting computer 46, such as an IP address.

Entry LOCATION identifies a particular location of reporting computer 46.

Web wrapper software 36 reads host information file 35 to obtain address information for sending log file 34 to reporting computer 46. One type of address may include an electronic mail address, which web wrapper software 36 may use to pass through a corporate firewall, if the service provider is running one to protect its internal network.

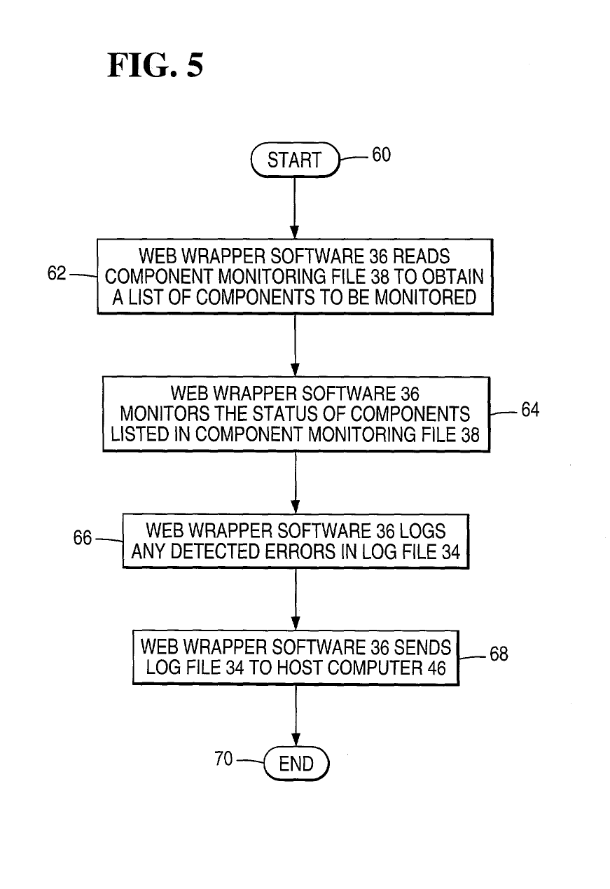

Turning now to FIG. 5, the method of the present invention is illustrated beginning with START 60.

In step 62, web wrapper software 36 reads component monitoring file 38 to obtain a list of components to be monitored. Web wrapper software 36 may be configured to automatically read component monitoring file 38 upon execution or manually after a change in component monitoring file 38.

In step 64, web wrapper software 36 monitors the status of components listed in component monitoring file 38. Monitoring may begin at scheduled times in component monitoring file 38 or upon command from reporting computer 46. Monitoring and reporting software 48 contacts kiosk 12 using address information in kiosk information file 50.

In step 66, web wrapper software 36 logs detected errors in log file 34.

In step 68, web wrapper software 36 sends log file 34 to reporting computer 46. Log file 34 may be sent at scheduled times or upon command from reporting computer 46. Log file 34 may be sent through conventional network communication methods or if necessary emailed to reporting computer 46. Web wrapper software 36 obtains address information for reporting computer 46 from host information file 35. Reporting computer 46 generates report file 56, which it sends to report delivery device 52, for display or printing. Service personnel may then use report file 56 to begin troubleshooting operating errors in monitored components.

Operation ends in step 70.

Although the present invention has been described with particular reference to certain preferred embodiments thereof, variations and modifications of the present invention can be effected within the spirit and scope of the following claims.

We claim:

1. A method of monitoring a network kiosk comprising the steps of:
determining kiosk components to monitor by the kiosk;
determining operating errors for a number of the kiosk components by the kiosk;
storing the operating errors in a log;
sending the log to a reporting computer by the kiosk; and
generating an error report for service personnel from the log by the reporting computer.

2. A method of monitoring a network kiosk comprising the steps of:
determining kiosk components to monitor by the kiosk;
determining a schedule for monitoring the kiosk components;
determining operating errors for a number of the kiosk components by the kiosk during scheduled monitoring;
storing the operating errors in a log;
sending the log to a reporting computer by the kiosk; and
generating an error report for service personnel from the log by the reporting computer.

3. The method as recited in claim 2, wherein the step of sending comprises the substep of:
emailing the log to the reporting computer by the kiosk.

4. The method as recited in claim 2, wherein the step of generating comprises the substep of:
generating a hypertext markup language (HTML) error report for service personnel from the log by the reporting computer.

5. A network kiosk comprising:
a plurality of components including a storage medium; and
a computer which determines first components to monitor, determines operating errors for second components of the first components, stores the operating errors in a log in the storage medium, and sends the log to a reporting computer.

6. The kiosk as recited in claim 4, wherein the computer emails the log to the reporting computer.

7. A network kiosk comprising:
a plurality of components including a storage medium; and
a computer which determines first components to monitor, determines a schedule for monitoring the first components, determines operating errors for second components of the first components during scheduled monitoring, stores the operating errors in a log in the storage medium, and sends the log to a reporting computer.

8. A network kiosk comprising:
a plurality of components including a card reader, a printer, a bar code reader, a touch screen, and a storage medium; and
a computer which monitors the components for operating errors, determines operating errors in a number of the components, stores the operating errors in a log in the storage medium, and sends the log to a reporting computer.

9. A kiosk monitoring system comprising:
a kiosk including a plurality of components including a storage medium, and a computer which determines first components to monitor, determines operating errors for second components of the first components, and stores the operating errors in a log in the storage medium; and
a reporting computer for generating reports containing the operating errors for kiosk service personnel, wherein the reporting computer receives the log from the kiosk in order to generate the reports.
